(19) United States
(12) Patent Application Publication
(10) Pub. No.: US 2007/0088128 A1
(43) Pub. Date: Apr. 19, 2007

(54) Elastomer composition and rubber roller composed of elastomer composition

(75) Inventor: Akira Minagoshi, Hyogo (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 11/543,154

(22) Filed: Oct. 5, 2006

(30) Foreign Application Priority Data
Oct. 18, 2005 (JP) 2005-303032

(51) Int. Cl. C08F 8/00

(52) U.S. Cl. 525/192

(57) ABSTRACT

An elastomer composition containing 2 to 150 parts by mass of a mixture of a thermoplastic elastomer and a thermoplastic resin, 50 to 250 parts by mass of a softener, and 0.2 to 3.0 parts by mass of an organic peroxide serving as a crosslinking agent, and 2 to 20 parts by mass of a resin crosslinking agent with respect to 100 parts by mass of a rubber component containing diene rubber and/or ethylene-propylene-diene rubber. The rubber component is dynamically crosslinked to disperse the rubber component in the mixture of the thermoplastic elastomer and the thermoplastic resin.

This nonprovisional application claims priority under 35 U.S.C. § 119(a) on Patent Application No(s). 2005-303032 filed in Japan on Oct. 18, 2005, the entire contents of which are hereby incorporated by reference.

### FIELD OF THE INVENTION

The present invention relates to an elastomer composition and a rubber roller composed of the elastomer composition. More particularly the present invention relates to an elastomer composition which has rubber elasticity, weatherability, and processability, is excellent in the wear resistance thereof, and is preferably used for a rubber roller for use in a paper-feeding mechanism of an image-forming apparatus such as an inkject printer, a laser printer, an electrostatic copying machine and an automatic teller machine (ATM).

A dynamically crosslinked thermoplastic elastomer dispersed in the thermoplastic elastomer and/or thermoplastic resin as a result of dynamic crosslinking of a rubber component shows a property similar to that of vulcanized rubber. Further by using equipment for processing the thermoplastic resin, the dynamically crosslinked thermoplastic elastomer can be adapted to any of injection molding method, extrusion molding method, and blow molding method. Furthermore the dynamically crosslinked thermoplastic elastomer does not require a heat-treating step such as a vulcanizing step after it is molded and can be recycled. Therefore the dynamically crosslinked thermoplastic elastomer adversely affects environment to a low extent and makes it easy to lower a total manufacturing cost. Owing to these advantages, the dynamically crosslinked thermoplastic elastomer is used to compose a high-function fuel-belt-tube, an air-break-hose, a weather strip for use in a car, a paper-feeding roller of an image-forming apparatus, and the like.

Wear resistance is one of performances demanded for the dynamically crosslinked thermoplastic elastomer used to compose the above-described products. When the elastomer composition is used to compose the paper-feeding roller of the image-forming apparatus, techniques for allowing the paper-feeding roller to have a low hardness are used so that it has a high frictional force with respect to paper. But the dynamically crosslinked thermoplastic elastomer having a low hardness has a low wear resistance.

Various methods for improving the wear resistance of the dynamically crosslinked thermoplastic elastomer have been proposed.

For example, in the description made in Japanese Patent Application Laid-Open No.11-236465 (patent document 1), the mixture of the hydrogenated styrene thermoplastic elastomer and the olefin resin is used as the matrix in a specific amount with respect to the rubber, and the rubber is dynamically vulcanized by resin vulcanization. Thereby the paper-feeding rubber roller containing the dynamically crosslinked thermoplastic elastomer is allowed to have an improved wear resistance.

In the description made in Japanese Patent Application Laid-Open No.2003-321580 (patent document 2), by using a compatibilizing agent, the rubber component and the thermoplastic component having opposite polarities are compatibilized to thereby alloy the mixture efficiently. By combining the nonpolar rubber excellent in weatherability with the polar thermoplastic resin or/and the thermoplastic elastomer excellent in the wear resistance, it is possible to obtain the thermoplastic elastomer composition excellent in the wear resistance thereof.

In the description made in Japanese Patent Application Laid-Open No.2004-331781 (patent document 3), the styrene thermoplastic elastomer (C) having double bonds is added in a specified ratio to the rubber component (A) containing diene rubber and/or ethylene-propylene-diene rubber (hereinafter referred to as EPDM rubber) and to the mixture composition (B) of the hydrogenated styrene thermoplastic elastomer and the olefin resin. Thereby it is possible to increase the strength of the elastomer composition and its wear resistance and particularly the wear resistance of the paper-feeding roller or the like composed of the elastomer composition when it is idling away.

The crosslinking agent is required to dynamically crosslink the rubber component. Paying attention to the crosslinking agent used in the above-described inventions, the use of the resin crosslinking agent, the use of the resin crosslinking agent or the peroxide crosslinking agent, and the use of the resin crosslinking agent are described in the patent document 1 (claim 1), the patent document 2 (claim 1), and the patent document 3 (claim 2) respectively.

In dynamically crosslinking the rubber component with the peroxide crosslinking agent, the main chain of the rubber and the resin is cut and crosslinked. Thus there is room for improvement when the thermoplastic elastomer composition is used to compose a product demanded to have a high wear resistance. The method of dynamically crosslinking the rubber component with the peroxide crosslinking agent has another problem that the components are defectively dispersed and a reaction occurs explosively during kneading of components. Consequently the kneaded components are discharged. Therefore there is a high possibility that the components cannot be processed.

In dynamically crosslinking the rubber component with the resin crosslinking agent, molecules of the diene rubber or the EPDM rubber having double bonds are crosslinked, but the hydrogenated styrene thermoplastic elastomer is hardly crosslinked. Thus this method has a limitation in the improvement of the wear resistance.

As described above, paying attention to the crosslinking agent, there is room for the improvement of the wear resistance in the above-described inventions.

Patent Document 1: Japanese Patent Application Laid-Open No.11-236465

Patent Document 2: Japanese Patent Application Laid-Open No.2003-321580

Patent Document 3: Japanese Patent Application Laid-Open No.2004-331781

### SUMMARY OF THE INVENTION

The present invention has been made in view of the above-described problems. Therefore it is an object of the present invention to provide an elastomer composition which has rubber elasticity characteristic of vulcanized rubber and weatherability and processability characteristic of resin and is excellent in its resistance to wear; and a rubber roller which is made of the elastomer composition, has a high coefficient of friction, and is durable, i.e., is capable of keeping the coefficient of friction for a long time.

To achieve the object, the present invention provides an elastomer composition containing 2 to 150 parts by mass of a mixture of a thermoplastic elastomer and a thermoplastic resin, 50 to 250 parts by mass of a softener, and 0.2 to 3.0 parts by mass of an organic peroxide serving as a crosslinking agent, and 2 to 20 parts by mass of a resin crosslinking agent with respect to 100 parts by mass of rubber component containing diene rubber and/or ethylene-propylene-diene rubber. The rubber component is dynamically crosslinked to disperse the rubber component in the mixture of the thermoplastic elastomer and the thermoplastic resin.

The present inventors have energetic researches on a method of crosslinking the dynamically crosslinked thermoplastic elastomer dispersed in the thermoplastic elastomer and/or thermoplastic resin as a result of dynamic crosslinking of the rubber component. As a result, they have found that the wear resistance of the dynamically crosslinked thermoplastic elastomer can be improved by adding the organic peroxide and the resin crosslinking agent in a specific amount to the dynamically crosslinked thermoplastic elastomer.

As the organic peroxides contained in the elastomer composition of the present invention, it is possible to use compounds capable of crosslinking the rubber component. For example, it is possible to list benzoyl peroxide, 1,1-bis (tert-butyl peroxy)-3,3,5-trimethylcyclohexane, 2,5-dimethyl-2,5-di-(benzoyl peroxy)hexane, di(tert-butyl peroxy)di-isopropylbenzene, 1,4-bis[(tert-butyl) peroxy isopropyl]benzene, di(tert-butyl peroxy)benzoate, tert-butyl peroxybenzoate, dicumyl peroxide, tert-butyl cumyl peroxide, 2,5-dimethyl-2,5-di (tert-butyl peroxy)hexane, di-tert-butyl peroxide, and 2,5-dimethyl-2,5-di(tert-peroxy)-3-hexene. These organic peroxides may be used singly or by mixing two or more of them with each other.

The mixing amount of the organic peroxide is set to 0.2 to 3.0 parts by mass with respect to 100 parts by mass of the rubber component. If the mixing amount of the organic peroxide is set to less than 0.2 parts by mass, the elastomer and the resin are insufficiently crosslinked. Thus the effect of improving the wear resistance of the elastomer composition cannot be obtained. On the other hand, if the mixing amount of the organic peroxide is set to more than 3.0 parts by mass, the property of the elastomer composition deteriorates because molecules are cut and in addition a defective dispersion occurs. Therefore it is difficult to process the elastomer composition.

The lower limit of the mixing amount of the organic peroxide with respect to 100 parts by mass of the rubber component is more favorably 0.5 parts by mass and most favorably 1.0 part by mass. The upper limit of the mixing amount of the organic peroxide with respect to 100 parts by mass of the rubber component is more favorably 2.5 parts by mass and most favorably 2.0 parts by mass.

A co-crosslinking agent may be used together with the organic peroxide. The co-crosslinking agent crosslinks itself and reacts with molecules of the rubber and crosslinks it, thus making the entire elastomer composition polymeric. By co-crosslinking the rubber component with the co-crosslinking agent, the molecular weights of the crosslinked molecules increase, and the wear resistance of the elastomer composition can be improved.

As the co-crosslinking agent, it is possible to list a polyfunctional monomer, metal salts of methacrylic acid or acrylic acid, methacrylate ester, aromatic vinyl compounds, heterocyclic vinyl compounds, allyl compounds, polyfunctional polymers utilizing the functional group of 1,2-polybutadiene, and dioximes.

When the co-crosslinking agent is added to the rubber component, together with the organic peroxide, the mixing amount of the co-crosslinking agent can be selected appropriately in relation to the kind of the co-crosslinking agent or other components. But the mixing amount of the co-crosslinking agent with respect to 100 parts by mass of the rubber component is favorably not less than 5 parts by mass nor more than 20 parts by mass and more favorably not less than 10 parts by mass nor more than 15 parts by mass.

The resin crosslinking agent contained in the elastomer composition of the present invention is synthetic resin which allows the rubber to make a crosslinking reaction by heating kneaded components of the elastomer composition. As the resin crosslinking agent, phenol resin, melamine-formaldehyde resin, triazine-formaldehyde condensate, hexamethoxymetyl-melamine resin are listed. It is preferable to use the phenol resin.

As the phenol resin, phenols such as phenol, alkylphenol, cresol, xylenol, and resorcin; and phenol resins synthesized by reactions of the phenols with aldehydes such as formaldehyde, acetaldehyde, and furfural. It is possible to use halogenated phenol resin having at least one halogen atom connected to the aldehyde unit of the phenolic resin.

It is especially preferable to use alkylphenol-formaldehyde resin resulting from the reaction of formaldehyde with alkylphenol having alkyl group connected to the ortho position or the para position of benzene, because the alkylphenol-formaldehyde resin is compatible with the rubber and reactive, thus making a crosslinking reaction start time comparatively early. Alkyl group of the alkylphenol-formaldehyde resin has 1-10 carbon atoms. More specifically, methyl group, ethyl group, propyl group, and butyl group are listed. It is possible to preferably use a halide of the alkylphenol-formaldehyde resin.

As the resin crosslinking agent, it is possible to use modified alkylphenol resin and alkylphenol sulfide resin formed by addition condensation of sulfurized-para-tertiary butyl phenol and aldehydes.

The mixing amount of the resin crosslinking agent is set to 2 to 20 parts by mass with respect to 100 parts by mass of the rubber component. If the mixing amount of the resin crosslinking agent is set to less than 2 parts by mass, the rubber component is insufficiently crosslinked. Thus the elastomer composition has an inferior wear resistance. On the other hand, if the mixing amount of the resin crosslinking agent is set to more than 20 parts by mass, a rubber roller composed of the elastomer composition is so hard that the rubber roller has a low friction for paper. The mixing amount of the resin crosslinking agent is set to favorably 5 to 15 parts by mass with respect to 100 parts by mass of the rubber component.

The mixing ratio between the organic peroxide and the resin crosslinking agent is not specifically limited. But favorably (mixing amount of organic peroxide):(mixing amount of resin crosslinking agent)=1:1 to 40 and more favorably 1:1 to 20.

The elastomer composition of the present invention contains at least one rubber component selected from among diene rubber and/or EPDM rubber.

As the diene rubber that is used in the present invention, it is possible to list natural rubber (NR), butyl rubber (IIR), isoprene rubber (IR), butadiene rubber (BR), styrene-butadiene rubber (SBR), chloroprene rubber (CR), acrylonitrile butadiene rubber (NBR), and 1,2-polybutadiene. These diene rubbers may be used singly or by mixing two or more of them with each other.

The EPDM rubber includes non oil-extended EPDM rubber consisting of a rubber component and oil-extended EPDM rubber containing the rubber component and oil extender. Both the non oil-extended EPDM and the oil-extended EPDM rubber can be used in the present invention. As examples of diene monomers in the EPDM rubber, dicyclopentadiene, methylenenorbornene, ethylidenenorbornene, 1,4-hexadiene, and cyclooctadiene are listed.

The rubber component may include rubber other than the diene rubber and the EPDM rubber. As the other rubber, ethylene propylene rubber, acrylic rubber, and chlorosulfonated polyethylene are listed.

The elastomer composition of the present invention essentially contains the EPDM rubber as the rubber component thereof. The ratio of the content of the EPDM rubber to the entire rubber component is favorably not less than 50 mass %, more favorably not less than 80 mass %, and most favorably not less than 95 to 100 mass %. The main chain of the EPDM rubber consists of saturated hydrocarbon and does not contain a double bond. Thus even though the EPDM rubber is exposed to a high-concentration ozone atmosphere or irradiated with light beams, the molecular main chain thereof is hardly cut. Therefore a product, for example, a rubber roller composed of the elastomer composition containing the EPDM rubber is allowed to have a high weatherability.

The elastomer composition of the present invention contains the mixture of the thermoplastic elastomer and the thermoplastic resin. It is preferable that the mixture of the thermoplastic elastomer and the thermoplastic resin is present as the elastomer after the thermoplastic elastomer and the thermoplastic resin are mixed with each other. This is because the obtained elastomer composition containing the rubber component dispersed in the mixture of the thermoplastic elastomer and the thermoplastic resin has a lower hardness.

Known thermoplastic elastomers can be used as the above-described thermoplastic elastomer. More specifically, it is possible to list styrene elastomer, chlorinated polyethylene, vinyl chloride elastomer, olefin elastomer, urethane elastomer, ester elastomer, amide elastomer, ionomer, ethylene ethyl acrylate resin (EEA), and ethylene-vinyl acetate copolymer (EVA).

Of the above-described thermoplastic elastomers, it is preferable to use the styrene elastomer. As the styrene elastomer, it is possible to list a block copolymer of a polymeric block (A) composed mainly of a styrene monomer and a block (B) composed mainly of a conjugated diene compound; and a hydrogenated block copolymer in which the polymeric unit of the conjugated diene of the above-described block copolymer is hydrogenated. As the styrene monomer, it is possible to list styrene, α-methylstyrene, vinyl toluene, and t-butyl styrene. It is possible to use these monomers singly or by mixing two or more of them with each other. Of the styrene monomers, the styrene is preferable. As the conjugated diene compound, it is possible to list butadiene, isoprene, chloroprene, 2,3-dimethylbutadiene. It is possible to use these conjugated diene compound singly or by mixing two or more of them with each other.

As the styrene elastomer, styrene-butadiene-styrene copolymer (SBS), styrene-isoprene-styrene copolymer (SIS), styrene-ethylene/butylene-styrene copolymer (SEBS), styrene-ethylene/propylene-styrene copolymer (SEPS), and styrene-ethylene-ethylene/propylene-styrene copolymer (SEEPS).

Of the styrene elastomer, it is favorable to use a hydrogenated styrene thermoplastic elastomer and more favorable to use the styrene-ethylene-ethylene/propylene-styrene copolymer (SEEPS).

As the thermoplastic resin, known thermoplastic resin can be used. For example, it is possible to use olefin resin, polystyrene (PS), polyethylene terephthalate (PET), polybutylene terephthalate (PBT), and nylon. It is preferable to use the olefin resin. As the olefin resin, polyethylene, polypropylene, ethylene ethyl acrylate resin, ethylene vinyl acetate resin, ethylene-methacrylate resin, and ionomer resin. Of these olefin resins, it is favorable to use the polypropylene or the polyethylene. It is more favorable to use the polypropylene.

The elastomer composition of the present invention contains 2 to 150 parts by mass of the mixture of the thermoplastic elastomer and the thermoplastic resin with respect to 100 parts by mass of the rubber component.

If the mixing amount of the mixture of the thermoplastic elastomer and the thermoplastic resin is less than two parts by mass, the amount of the resin component is so small that it is difficult to disperse the rubber component in the matrix resin and hence difficult to process the elastomer composition, and the product composed of the elastomer composition has a low strength and a low wear resistance. On the other hand, when the mixing amount of the mixture is more than 150 parts by mass, the amount of the resin component is so large that the elastomer composition has a high hardness. Consequently when the rubber roller composed of the elastomer composition is used as the paper-feeding roller, it has a low coefficient of friction in relation to paper and a low wear resistance.

The mixing ratio between the thermoplastic elastomer and the thermoplastic resin can be determined appropriately in dependence on the elastomer and the resin to be used. It is favorable to use not less than 1 nor more than 100 parts by mass of the thermoplastic resin with respect to 100 parts by mass of the thermoplastic elastomer. If the mixing amount of the thermoplastic resin is less than one part by mass, it is impossible to obtain the effect of mixing the thermoplastic resin with the thermoplastic elastomer. On the other hand, if the mixing amount of the thermoplastic resin is more than 100 parts by mass, it is impossible to allow the mixture to be the elastomer. It is more favorable to use not less than 20 nor more than 80 parts by mass of the thermoplastic resin with respect to 100 parts by mass of the thermoplastic elastomer.

The elastomer composition of the present invention contains a softener at 50 to 250 parts by mass with respect to 100 parts by mass of the rubber component. If the mixing amount of the softener is less than 50 parts by mass, it is difficult to process the elastomer composition into a product and mold the elastomer composition into a rubber roller having a low hardness. On the other hand, if the mixing amount of the softener is more than 250 parts by mass, the rubber roller composed of the elastomer composition has a low strength and wear resistance.

As the softener, petroleum-based softeners and plasticizers can be used. As the petroleum-based softeners, it is possible to use mineral oil such as aromatic oil, naphthenic oil, paraffin oil; and known synthetic oil consisting of hydrocarbon oligomer; and process oil. As the plasticizer, it is possible to use phthalate, adipate plasticizer, sebacate plasticizer, phosphate plasticizer, polyether plasticizer, and polyester plasticizer.

In the present invention, the paraffin oil is preferable as the softener. It is preferable that the paraffin oil does not contain aromatic hydrocarbon because the paraffin oil contaminates paper if it contains even a small amount of the aromatic hydrocarbon. In the present invention, paraffin process oil can be most favorably used as the softener.

The elastomer composition of the present invention may contain fillers as necessary. As fillers, it is possible to use powder of silica, carbon black, clay, talc, calcium. carbonate, dibasic phosphite (DLP), basic magnesium carbonate, and alumina. It is preferable that the mixing ratio of the filler is not more than 15 mass % of the mass of the entire elastomer composition for the following reason. The addition of the filler is effective for improving the tensile strength of the elastomer composition and its tear strength. But if the elastomer composition contains a very large amount of the filler, the flexibility of the elastomer composition deteriorates. Thereby the rubber roller composed of the elastomer composition has a low coefficient of friction.

The elastomer composition of the present invention may contain additives such as an age resistor, an antioxidant, an ultraviolet-absorbing agent, a lubricant, a pigment, an antistatic agent, a flame retardant, a neutralizer, a nucleus-forming agent, and a foaming prevention agent in addition to the above-described components.

The mixing amount of the polymer component (rubber component+thermoplastic elastomer+thermoplastic resin+resin crosslinking agent+other additive resin) excluding non-polymer components such as the softener, the filler, and the like with respect to the entire elastomer composition is set to favorably not less than 40 parts by mass nor more than 95 parts by mass and more favorably not less than 59 parts by mass nor more than 95 parts by mass.

The mixing amount of the polymer component with respect to the entire elastomer composition is set to not less than 40 parts by mass to secure the wear resistance of the elastomer composition. The mixing amount of the polymer component with respect to the entire elastomer composition is set to not more than 95 parts by mass to secure processability of the elastomer composition in a kneading operation and moldability thereof.

In the elastomer composition of the present invention, the rubber component is dynamically crosslinked with the crosslinking agent to disperse the rubber component in the mixture of the thermoplastic elastomer and the thermoplastic resin.

The rubber component may be dynamically crosslinked in the presence of halogen, namely, chlorine, bromine, fluorine or iodine. To allow the halogen to be present in a dynamic crosslinking time, the elastomer composition contains a halogenated resin crosslinking agent or a halogen donor. As the halogen donor, tin chloride such as stannic chloride, ferric chloride, and cupric chloride are listed. The halogen donor can be used singly or in combination of two or more thereof.

A crosslinking assistant (activator) may be used to accomplish a cross-linking reaction properly. Metal oxides are used as the crosslinking assistant. As the metal oxide, zinc oxide and zinc carbonate are preferable.

The elastomer composition of the present invention can be produced by carrying out a method described below.

The rubber component, the mixture of the thermoplastic elastomer and the thermoplastic resin, the softener, the organic peroxide and the resin crosslinking agent serving as the crosslinking agent, and other additives to be used as desired are supplied into a kneading machine such as a Henschel mixer, a super mixer, a tumbler-type mixer to knead them. The kneaded components are supplied to a single screw extruder, a twin screw extruder or a kneader. Thereafter the rubber component is dynamically crosslinked with the crosslinking agent while the components are being heated at 150 to 250° C. to disperse the rubber component in the mixture of the thermoplastic elastomer and the thermoplastic resin.

The elastomer composition of the present invention can be used for various purposes. Above all, it is preferable to use the elastomer composition as members contributing to feeding of paper in office automation appliances such as a copying machine, a printer, a facsimile, an ATM, and the like. More specifically, the elastomer composition can be used to form a separation sheet and a separation pad for preventing a plurality of paper from being fed together and the paper-feeding roller. It is especially preferable to use the elastomer composition to compose the paper-feeding roller such as a paper supply roller, a paper transport roller, a paper discharge roller, and the like constructing a paper supply mechanism of the image-forming apparatus.

The present invention provides the rubber roller formed by molding the elastomer composition of the present invention.

The rubber roller may have any constructions, provided that the rubber roller has a layer consisting of the elastomer composition of the present invention on at least the surface thereof. But the rubber roller having the single layer consisting of the elastomer composition of the present invention has a simple construction and is preferable in view of the management of the manufacturing process and the manufacturing cost. The rubber roller of the present invention is used with a shaft made of metal or ceramics inserted into the center thereof.

The thickness of the rubber roller is set to favorably 1 to 20 mm and more favorably 2 to 20 mm. If the thickness of the rubber roller is less than 1 mm, the rubber roller lacks elasticity. Therefore, the transfer performance of the rubber roller tends to deteriorate. On the other hand, if the thickness of the rubber roller is more than 20 mm, the rubber roller is so large that it is difficult to mount the rubber roller on a copying machine, a printer, and the like.

The hardness of the rubber roller of the present invention measured in accordance with JIS K 6253 is not less than 20 nor more than 50, because the rubber roller having the hardness in the range of 20 to 50 shows preferable flexibility. Thus when the rubber roller is pressed against paper or a film at a comparatively small force, the rubber roller deforms sufficiently and contacts the paper or the film in a large area. If the rubber roller has a hardness less than 20, it has a large wear amount. If the rubber roller has a hardness more than 50, there occurs a problem that the rubber roller does not feed paper during a paper-feeding operation. The hardness of the rubber roller is more favorably not less than 30 nor more than 50 and most favorably not less than 35 nor more than 45.

The rubber roller of the present invention can be manufactured by carrying out a method described below.

After the elastomer composition of the present invention is extruded from a twin screw extruder to obtain a pellet, the pellet is extruded tubularly by an extruder. The tube may be cut to obtain the rubber roller. Alternatively after the pellet may be injected by an injection molding machine to mold it tubularly, the surface of the molded tube is polished, and the molded tube is cut to a required dimension to obtain the rubber roller.

The elastomer composition of the present invention displays an excellent wear resistance because it contains a specified amount of the organic peroxide serving as the crosslinking agent and a specified amount of the resin crosslinking agent used in combination with the organic peroxide.

In the elastomer composition of the present invention, the rubber component is dynamically crosslinked to disperse it in the mixture of the thermoplastic elastomer and the thermoplastic resin. Therefore the elastomer composition displays an elastic property similar to that of vulcanized rubber and excellent in its weatherability similar to resin and can be adapted to any of injection molding method, extrusion molding method, and blow molding method. Furthermore unlike the vulcanized rubber, the thermoplastic elastomer does not require a heat-treating step such as a vulcanizing step after it is molded and can be recycled. Therefore the elastomer composition adversely affects environment to a low extent and makes it easy to lower the total manufacturing cost.

The rubber roller of the present invention has a high coefficient of friction and a hardness not less than 30 nor more than 50. Therefore when the rubber roller is used as the paper-feeding roller of OA appliances such as a copying machine, a printer, and the like, the paper-feeding roller has a high paper-feeding performance and prevents defective paper feeding, for example, unfeeding of the paper.

### BRIEF DESCRIPTION OF THE DRAWINGS

FIG. 1 is an illustration of an apparatus for measuring a coefficient of friction in an embodiment of the present invention.

### DETAILED DESCRIPTION OF THE PREFERRED EMBODIMENTS

The embodiments of the present invention will be described below.

The elastomer composition of the embodiment contains a rubber component consisting of EPDM (ethylene-propylene-diene rubber); a mixture of a hydrogenated styrene thermoplastic elastomer and polypropylene which is a thermoplastic resin; a softener consisting of paraffin process oil; and a phenol resin crosslinking agent; and an organic peroxide, consisting of 2,5-dimethyl-2,5-di(t-butyl peroxy)hexane, which is used as a crosslinking agent. The rubber component is dynamically crosslinked with the crosslinking agents to disperse the rubber component in a mixture of the thermoplastic elastomer and the thermoplastic resin.

The mixing amount of the phenol resin crosslinking agent with respect to 100 parts by mass of the rubber component is set to not less than 1.0 parts by mass nor more than 2.0 parts by mass. The mixing amount of the organic peroxide consisting of the 2,5-dimethyl-2,5-di(t-butyl peroxy)hexane with respect to 100 parts by mass of the rubber component is set to not less than 5 parts by mass nor more than 15 parts by mass.

The mixing ratio between the organic peroxide and the resin crosslinking agent is set as follows: (mixing amount of organic peroxide):(mixing amount of resin crosslinking agent)=1:1 to 10 and favorably 1:2 to 10.

As described above, the elastomer composition contains the EPDM rubber as its rubber component and the mixture of the hydrogenated styrene thermoplastic elastomer and the polypropylene.

The mixing amount of the mixture of the hydrogenated styrene thermoplastic elastomer and the polypropylene with respect to 100 parts by mass of the EPDM rubber is set to 30 to 100 and preferably 50 to 90 parts by mass. Regarding the mixing ratio between the hydrogenated styrene thermoplastic elastomer of the mixture and the polypropylene thereof, 10 to 80 and preferably 20 to 60 parts by mass of the polypropylene is used with respect to 100 parts by mass of the hydrogenated styrene thermoplastic elastomer.

The paraffin process oil is used at 100 to 250 parts by mass and preferably 150 to 250 parts by mass with respect to 100 parts by mass of the EPDM rubber.

It is preferable that the elastomer composition of the present invention contains zinc oxide as its crosslinking assistant. The zinc oxide is used at 1 to 10 parts by mass with respect to 100 parts by mass of the EPDM rubber.

After the above-described components are supplied to a tumbler-type kneading machine at a desired mixing ratio, they are kneaded at 150 to 300° C. and preferably at 200 to 250° C. for 1 to 60 minutes and preferably for 5 to 30 minutes. The obtained kneaded components are supplied to a twin screw extruder to dynamically crosslink the rubber component at 150 to 250° C. and preferably at 200° C. Thereby the rubber component is uniformly dispersed in the mixture of the hydrogenated styrene thermoplastic elastomer and the polypropylene to obtain a pellet of the elastomer composition of the present invention.

After the pellet is extruded tubularly by using a single screw extruder at 190 to 230° C., a shaft made of metal is inserted into a hollow portion of the tube by press fit or both are bonded to each other with an adhesive agent. In this manner, the rubber roller of the present invention is obtained.

An approximately D-shaped shaft is inserted into the hollow portion of the cylindrically shaped rubber roller by press fit. Thereby it is possible to obtain an approximately D-shaped rubber roller. A knurled groove may be formed on the surface of the rubber roller of the present invention.

The rubber roller manufactured in the above-described processes has a hardness not less than 30 nor more than 50 when it is measured in accordance with JIS K 6253.

### EXAMPLES

Examples of the present invention and comparison examples are described in detail below.

Rubber rollers of the examples and the comparison examples were manufactured by using the elastomer compositions having the mixing ratios shown in table 1. Each rubber roller was evaluated in its hardness, wear resistance, and coefficient of friction by carrying out a method described below. Table 1 shows the results of the evaluation.

TABLE 1

| | E1 | E2 | CE1 | CE2 | CE3 | CE4 | CE5 | CE6 |
|---|---|---|---|---|---|---|---|---|
| EPDM rubber | 100 | 100 | 100 | 100 | 100 | 100 | 100 | 100 |
| Thermoplastic elastomer | 50 | 50 | 50 | 50 | 50 | 50 | 50 | 50 |
| Thermoplastic resin | 20 | 20 | 20 | 20 | 20 | 20 | 20 | 20 |
| Softener | 200 | 200 | 200 | 200 | 200 | 200 | 200 | 200 |
| Organic peroxide | 1 | 2 | 2 | | 0.1 | 4 | 2 | 2 |
| Resin crosslinking agent | 8 | 12 | | 12 | 12 | 12 | 1 | 25 |
| Crosslinking assistant | 5 | 5 | 5 | 5 | 5 | 5 | 5 | 5 |
| Hardness | 37 | 43 | 40 | 40 | 40 | 45 | 41 | 54 |
| Wear resistance | 110 | 115 | 100 | 103 | 99 | 105 | 101 | 120 |
| Coefficient of friction | 106 | 102 | 100 | 98 | 100 | 100 | 99 | 88 |

E and CE in the uppermost column indicate example and comparison example respectively.

The following products were used for the components shown in table 1:

EPDM rubber: “Esprene 505A” produced by Sumitomo Chemical Co.,Ltd.

Thermoplastic elastomer: hydrogenated styrene thermoplastic elastomer (“Septon 4077” produced by Kuraray Co., Ltd.)

Thermoplastic resin: polypropylene (“Novatec PP” produced by Japan Polypropylene Corporation.)

Softener: Paraffin process oil (“Diana process oil PW-380” produced by Idemitsu Kosan Co., Ltd.)

Organic peroxide: 2,5-methyl-2,5-di(t-butyl peroxy)hexane (“Perhexa 25B-40” produced by NOF Corporation. (Purity 40%))

Resin crosslinking agent: Phenol resin crosslinking agent (“Tackrol 250-III” produced by Taoka Chemical Co., Ltd.)

Crosslinking assistant: Zinc white (“Zinc White No. 1” produced by Mitsui Mining and Smelting Co., Ltd.)

The rubber roller was manufactured by the following processes:

After the weights of the components were measured, the EPDM rubber, the thermoplastic elastomer, the thermoplastic resin, the softener, the organic peroxide, the resin crosslinking agent, and the crosslinking assistant were supplied to a tumbler and mixed with one another for 10 minutes. After the EPDM rubber was dynamically crosslinked with the twin screw extruder (HTM 38 manufactured by Ibeck Inc.) at 200° C. to obtain the elastomer composition. Thereafter the elastomer composition was extruded to obtain a pellet.

Thereafter the pellet was extruded tubularly at 20 rpm and at a temperature of 190° C. to 230° C. by using a single screw extruder (ø50 extruder manufactured by Kasamatsu Kako Kenkyusho Inc.) to obtain a molded product having an outer diameter of 22 mm and an inner diameter of 18 mm. The tubular molded product was cut to obtain a rubber roller having a width of 15 mm and a shaft inserted into and fixed to the hollow portion thereof.

The method of examining the hardness, wear resistance, and coefficient of friction of the rubber roller is shown below.

Hardness

The hardness of each rubber roller was measured at an atmospheric temperature of 23° C. in accordance with JIS K 6253.

Wear Resistance

The rubber roller of each of the examples and the comparison examples was mounted on a copying machine as a paper supply roller. 20,000 sheets of paper (manufactured by Fuji Xerox Office Supply Corporation.) of size A4 were supplied to the copying machine at a temperature of 23° C. and a relative humidity of 55% for 10 hours. The mass of each rubber roller was measured before and after the test was conducted to find the abrasion wear. In table 1, the abrasion wear of each rubber roller is shown by an index with respect to 100 which was set as the abrasion wear of the rubber roller of the comparison example 1. The larger the index is, the better the wear resistance is.

Coefficient of Friction

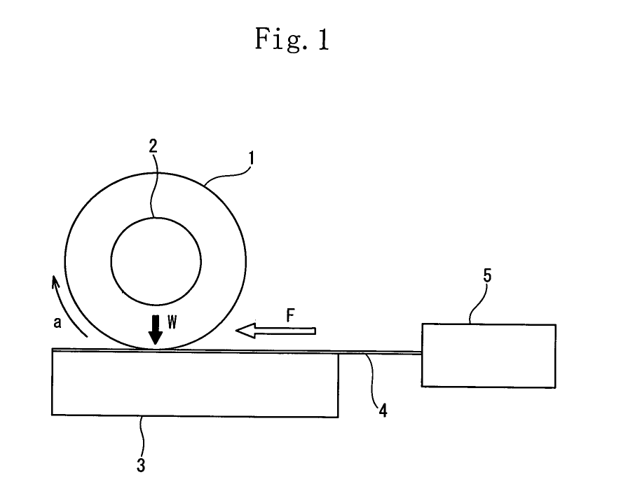

The coefficient of friction was evaluated by using an apparatus shown in FIG. 1.

As shown with a black arrow of FIG. 1, each rubber roller 1 was pressed against a plate 3 by applying a vertical load W of 250gf to a shaft 2 of the rubber roller 1, with PPC paper (manufactured by Fuji Xerox Office Supply Corporation.) of size A4 sandwiched between the rubber roller 1 and the plate 3. The PPC paper was connected with a load cell 5. The rubber roller 1 was rotated at a peripheral speed of 300 mm/second in the direction shown with an arrow (a) at a temperature of 23° C. and a humidity of 55%. A force F(gf) generated in the direction shown with a white arrow in FIG. 1 was measured by the load cell 5. By using an equation (1) shown below, the coefficient of friction μ was computed from the measured force F (gf) and the load W (250gf).

In table 1, the coefficient of friction of each rubber roller is shown by an index with respect to 100 set as the coefficient of friction of the rubber roller of the comparison example 1. The larger the index is, the higher the coefficient of friction is. Thus the rubber roller having a high coefficient of friction has an excellent paper-feeding performance.
μ=F(gf)/W(gf) . . . Equation 1

It was confirmed that the rubber rollers of the comparison examples 2 through 6 were inferior to the rubber roller of the comparison example 1 in the wear resistance or in the coefficient of friction and that the rubber rollers of the examples 1, 2 were superior to the rubber roller of the comparison example 1 in both the wear resistance and the coefficient of friction.

What is claimed is:

1. An elastomer composition comprising 2 to 150 parts by mass of a mixture of a thermoplastic elastomer and a thermoplastic resin, 50 to 250 parts by mass of a softener, and 0.2 to 3.0 parts by mass of an organic peroxide serving as a crosslinking agent, and 2 to 20 parts by mass of a resin crosslinking agent with respect to 100 parts by mass of a rubber component containing diene rubber and/or ethylene-propylene-diene rubber,
wherein said rubber component is dynamically crosslinked with said crosslinking agents to disperse said rubber component in said mixture of said thermoplastic elastomer and said thermoplastic resin.

2. The elastomer composition according to claim 1, wherein said thermoplastic elastomer is a hydrogenated styrene thermoplastic elastomer.

3. A rubber roller formed by molding the elastomer composition according to claim 1.

4. A rubber roller formed by molding the elastomer composition according to claim 2.

5. The rubber roller, according to claim 3, having a hardness not less than 20 nor more than 50 when said hardness is measured in accordance with JIS K 6253.

6. The rubber roller, according to claim 4, having a hardness not less than 20 nor more than 50 when said hardness is measured in accordance with JIS K 6253.

7. The rubber roller, according to claim 3, used as a paper-feeding roller of an image-forming apparatus.

8. The rubber roller, according to claim 4, used as a paper-feeding roller of an image-forming apparatus.

9. The rubber roller, according to claim 5, used as a paper-feeding roller of an image-forming apparatus.

10. The rubber roller, according to claim 6, used as a paper-feeding roller of an image-forming apparatus.
